(19) United States
(12) Patent Application Publication
(10) Pub. No.: US 2007/0154602 A1
(43) Pub. Date: Jul. 5, 2007

(54) Treatment of cooking oils and fats with calcium silicate-based materials

(76) Inventors: Michael C. Withiam, Landenberg, PA (US); Nolan Lee Phillips, Perryville, MD (US); Duen-Wu Hua, Edgewood, MD (US); William C. Fultz, Risiing Sun, MD (US); Parick Donald McGill, Darlington, MD (US)

Correspondence Address: J M HUBER CORPORATION, 333 THORNALL STREET, PATENT DEPARTMENT, EDISON, NJ, 08837-2220, US

(21) Appl. No.: 11/323,663

(22) Filed: Dec. 30, 2005

(51) Int. Cl. A23C 15/14

(52) U.S. Cl. 426/417

(57) ABSTRACT

The treatment of cooking oils and fats with specific types of calcium silicate-based materials to prolong the useful life of such oils and fats within restaurant settings is provided. More particularly, such an invention encompasses the utilization of calcium-based aluminosilicate materials to filter such oils and/or fats or the incorporation of calcium silicate with or within previously utilized cooking oil filter materials (such as magnesium silicate) for the same purpose. Such calcium silicate-based materials and treatments therewith aid to remove greater amounts of free fatty acids after such oils and/or fats have been utilized to fry foodstuffs, as well as reduce the amount of additional oil and/or fat potentially necessary to bring the used oils and/or fats up to a level of permitted further utilization within a restaurant environment.

### FIELD OF THE INVENTION

This invention relates to the treatment of cooking oils and fats with specific types of calcium silicate-based materials to prolong the useful life of such oils and fats within restaurant settings. More particularly, such an invention encompasses the utilization of calcium-based aluminosilicate materials to filter such oils and/or fats or the incorporation of calcium silicate with or within previously utilized cooking oil filter materials (such as magnesium silicate) for the same purpose. Such calcium silicate-based materials and treatments therewith aid to remove greater amounts of free fatty acids after such oils and/or fats have been utilized to fry foodstuffs, as well as reduce the amount of additional oil and/or fat potentially necessary to bring the used oils and/or fats up to a level of permitted further utilization within a restaurant environment.

### BACKGROUND OF THE PRIOR ART

Cooking oils and fats are employed in general for the cooking or frying of foods such as chicken, fish, potatoes, potato chips, vegetables, and pies. Such frying may take place in a home or restaurant wherein food is prepared for immediate consumption or in an industrial frying operation where food is prepared in mass quantities for packaging, shipping, and future consumption.

In a typical restaurant frying operation, large quantities of edible cooking oils or fats are heated in vats to temperatures of from about 315 to about 400° F. or more, and the food is immersed in the oil or fat for cooking. During repeated use of the cooking oil or fat the high cooking temperatures, in combination with water from the food being fried, cause the formation of free fatty acids (or FFA). An increase in the FFA decreases the oil's smoke point and results in increasing smoke as the oil ages. Increased FFA content also causes excessive foaming of the hot fat and contributes to an undesirable flavor or development of dark color. Any or all of these qualities associated with the fat can decrease the quality of the fried food.

Industrial frying operations involve the frying of large amounts of food for delayed consumption. Often, this is a continuous operation with the food being carried through the hot oil via a conveyor. Industrial fryers of meat and poultry must follow the strict FDA guidelines in terms of the length of time oils and fats may be used for deep fat frying purposes. Suitability of further or prolonged use can be determined from the degree of foaming during use or from color and odor of the oil and/or fat or from the flavor of the resultant fried food made therefrom. Fat or oil should be discarded when it foams over a vessel's side during cooking, or when its color becomes almost black as viewed through a colorless glass container. Filtering of used oil and/or fat is permitted, however, to permit further use, as well as adding fresh fat to a vessel and cleaning frying equipment regularly. Large amounts of sediment and free fatty acid content in excess of 2 percent are usual indications that frying fats are unwholesome and require reconditioning or replacement. Most industrial fryers use the 2% free fatty acid (FFA) limit, or less if mandated by their customers, for poultry as their main specification for oil quality, regardless of the food being fried.

In addition to hydrolysis, which forms free fatty acids, there occurs oxidative degeneration of fats which results from contact of air with hot oil, thereby producing oxidized fatty acids (or OFA). Heating transforms the oxidized fatty acids into secondary and tertiary by-products which may cause off-flavors and off-odors in the oil and fried food. Caramelization also occurs during the use of oil over a period of time, resulting in a very dark color of the oil which, combined with other by-products, produces dark and unappealing fried foods. Because of the cost resulting from the replacing of the cooking oils and fats after the use thereof, the food industries have searched for effective and economical ways to slow degradation of fats and oils in order to extend their usable life.

U.S. Pat. No. 5,597,600, issued to Munson et al., utilizes magnesium silicate of certain particle size to filter such used oils and/or fats as well. Such magnesium silicate materials provide effective filtering of such cooking oils and fats; however, there are limitations to free fatty acid removal levels as well as the need for relatively large amounts of extra oils and/or fats to be added to used sources in order to attain acceptable frying conditions.

Also in the prior art is a synthetic calcium silicate known in the trade under the name Silasorb® (Celite Corporation, Denver, Colo.). Such a product has been utilized as a proper filter media because it is very effective in lowering free fatty acid concentration. Silasorb lowers the free fatty acid (FFA) concentration of the oil by a combination of adsorption and neutralization. The use of such a material, however, often darkens the oil to a suspect level. In addition, the product of the neutralization of a fatty acid with an alkaline metal is a fatty acid soap. The amount of soap formed is dependent on the amount of alkaline metal present, and the initial percentage of free fatty acids in the oil. When the soap level is high, the oil foams. The use of Silasorb® in order to lower the free fatty acid concentration sometimes results in uncontrollable foaming.

There exists thus a definite need to improve each of these prior developments within the cooking oil/fat filtering area. A material and/or method that provides improved levels of free fatty acid reduction, improved color, and/or a significant reduction in the needed amount of added fresh oil or fat to be added to a used source would provide a much sought after advancement to the restaurant and/or industrial frying markets.

### SUMMARY OF THE INVENTION

It is therefore an advantage of the present invention to provide an improved procedure for removing free fatty acids from cooking oil or fat employed in restaurant frying operations or in industrial frying operations as compared with such previous developments. Another advantage is the ability to simultaneously utilize the benefits of certain materials within the prior art with supplementation of effects from the calcium silicate-based material additives of this invention.

Accordingly, this invention encompasses a method for treating cooking oil or fat comprising contacting cooking oil or fat with a compound selected from the group consisting of a calcium magnesium aluminosilicate, a sodium magnesium aluminosilicate, and mixtures thereof. Also encompassed within this invention is a method for treating cooking oil or fat comprising contacting cooking oil or fat with (a) a magnesium silicate (such as sodium magnesium aluminosilicate, as one example) and (b) at least one calcium silicate. Furthermore, such a blend of magnesium silicate and calcium silicate may in blended in dry or wet form.

### DETAILED DESCRIPTION OF THE INVENTION

The present invention is particularly advantageous in that the useful life of cooking oil and/or fat (shortening), which has been used for the high temperature frying of foods, can be extended, thereby reducing the overall cost. The utilization of a sodium magnesium aluminosilicate has not been undertaken previously for this type of filtering procedure. Furthermore, the production of an aluminosilicate produced as the reaction product of the same sodium magnesium aluminosilicate and calcium silicate (to produce, in effect, a sodium calcium magnesium aluminosilicate) is novel to the cooking oil filter industry as well. The production methods for these materials are noted below. It was further noted that an increase in the amount of calcium species present provided a certain improvement in filter efficacy, particularly for free fatty acid removal from target used oils and/or fats. Thus, it was theorized that utilization of free calcium silicate may offer an improvement as well within certain filter media (such as magnesium silicate alone). Additionally, then, it was surprisingly found that a certain degree in improvement of filtering ability (for free fatty acid removal, as above) is provided when a magnesium silicate (such as sodium magnesium aluminosilicate, as a non-limiting example) is physically mixed with a calcium silicate (Hubersorb® 600, for example), either in dry or wet form.

Of great importance, however, to this invention was the granulation of the produced materials to sufficiently large particle sizes (such as between 400 and 1600 microns, preferably between 425 and 850 microns). Specifically, a particle size that is too small will result in a propensity to clog a fryer vessel (if the added materials are freely introduced within such an area). If included within a filter apparatus, such a possibility is significantly reduced; however, the low surface area characteristics of the materials themselves also appeared to result in a lower degree of free fatty acid removal than for the granulated materials. Thus, granulation of particles of sodium magnesium aluminosilicate and/or sodium calcium magnesium silicate is needed to provide proper performance of cooking oil and/or fat filtration within this invention.

The resultant effects of free fatty acid removal, reduced discoloration, and overall “freshness” of the used cooking oil and/or fat were noted of these inventive materials and methods regardless of the pressures involved and flow rates followed. As such, these materials may be employed either as drop-in treatments or as materials within filter apparatuses for incorporation within frying systems and/or vessels. Other additives that may be included within these materials may include any type of material that contribute to improving oil and/or fat quality, including, without limitation, activated carbons (such as Activated Carbon Darco T-88 from American Norit Co., Jacksonville, Fla.), alumina (such as Basic pH Alumina A-2 from LaRoche Chemicals, Baton Rouge, La. and Neutral pH Alumina from M. Woelm Eschwege, Germany), bleaching materials (such as Bleaching Earth #1 Filtrol 105 from Harshow Filtrol, Cleveland, Ohio and Bleaching Earth #2 Tonsil Supreme La. from Saloman, Port Washington, N.Y.), silicates (such as Calcium Silicate Silasorb® from Manville Corp., Denver, Colo. and Magnesium Silicate MAGNESOL® XL from The Dallas Group, Whitehouse, N.J.), silicas (such as Silica #1 Britesorb® C200 from PQ Corp., Valley Forge, Pa. and Silica #2 Trisyl from W.R. Grace & Co., Baltimore, Md.), silica gel (such as Silica Gel 60 from Baxter Scientific Products, Obetz, Ohio), and Diatomaceous Earth (such as FW-18 from Eagle Picher, Reno, Nev.).

The method of the present invention is applicable to continuous filtration systems in which used cooking oil is circulated continuously through filtration units and back to the frying vats and/or vat systems wherein one or more times a day, the contents of each frying vat are filtered through a batch type filter. The granulated magnesium silicate-based compounds (sodium magnesium aluminosilicate, as one example) alone, and/or the blends with calcium silicate thereof, may be utilized either as a precoat or a body feed in either a continuous or batch filtration system, or both, if desired.

In a conventional cooking apparatus, or in an industrial frying application, in general, at least 0.005 lb. of the filter medium, and preferably at least 0.01 lb. of the composition, is employed per pound of used cooking oil. In general, the amount of filter medium employed does not exceed 0.02 lb. per pound of used cooking oil.

### PREFERRED EMBODIMENTS OF THE INVENTION

Surface area was determined by the BET nitrogen adsorption methods of Brunaur et al., J. Am. Chem. Soc., 60, 309 (1938).

Pack or tapped density was determined by weighing 20.0 grams of product into a 250-mL plastic graduated cylinder with a flat bottom. The cylinder was closed with a rubber stopper and placed on a tap density machine and run for 15 minutes. The tap density machine is a conventional motor-gear reducer drive operating a cam at 60 rpm. The cam is cut or designed to raise and drop the cylinder a distance of 2.25 inch (5.715 cm) every second. The tapped density was calculated as the volume occupied by a known weight of product and expressed in g/ml.

Pour density is determined by weighing 100.0 grams product into a 250-mL graduated cylinder and recording the volume occupied.

Median particle size (MPS) was determined using a Model LA-910 laser light scattering instrument available from Horiba Instruments, Boothwyn, Pa. A laser beam was projected through a transparent cell which contains a stream of moving particles suspended in a liquid. Light rays which strike the particles are scattered through angles which are inversely proportional to their sizes. The photodetector array measures the quantity of light at several predetermined angles. Electrical signals proportional to the measured light flux values are then processed by a microcomputer system to form a multi-channel histogram of the particle size distribution.

Oil absorption, using either linseed oil, was determined by the rubout method. This method is based on a principle of mixing oil with a silica by rubbing with a spatula on a smooth surface until a stiff putty-like paste is formed. By measuring the quantity of oil required to have a paste mixture, which will curl when spread out, one can calculate the oil absorption value of the silica−the value which represents the volume of oil required per unit weight of silica to saturate the silica sorptive capacity. Calculation of the oil absorption value was done as follows:

$$\begin{matrix}Oil absorption = \frac{ml oil absorbed}{weight of silica , grams} \times 100 \\ = ml oil / 100 gram silica\end{matrix}$$

The 5% pH was determined by weighing 5.0 grams silica into a 250-ml beaker, adding 95 ml deionized or distilled water, mixing for 7 minutes on a magnetic stir plate, and measuring the pH with a pH meter which has been standardized with two buffer solutions bracketing the expected pH range.

The chemical composition was determined according to the methods described in Food Chemicals Codex (FCC V) under the monographs for sodium magnesium aluminosilicate and calcium silicate.

To determine free fatty acid reductions, initial and treated oils were analyzed by the official American Oil Chemists' Society methods for percent free fatty acids (Ca 5a-40).

### EXAMPLE 1

A sodium magnesium aluminosilicate was prepared by adding 378 L of an aqueous sodium sulfate solution (11.4%) and 3.7 L of magnesium hydroxide slurry (50% solids) to a 400-gallon reactor and heating the mixture to 71° C. with stirring. An aqueous solution of alum [48% Al₂(SO₄)₃] was then added at 2.9 LPM for 3.5 minutes. After 3.5 minutes, the flow of alum was stopped and the batch was allowed to digest for 2 minutes. After the 2 minute digest time, sodium silicate (30%, 2.50 mole SiO₂:Na₂O) and alum [48% Al₂ (SO₄)₃] were added simultaneously at rates of 6.7 LPM and 2.9 LPM, respectively, for 35 minutes. After the 35 minute simultaneous addition time, the flow of silicate was stopped and the pH was adjusted to 6.5 with continued addition of alum. Once pH 6.5 was reached, the flow of alum was stopped and sodium silicate (30%, 2.50 mole SiO₂:Na₂O) was added for 4 minutes at 6.7 LPM. The reaction mass was now at pH 9.2±0.2. The batch was then digested for 15 minutes at 71° C. After the digestion time, the resulting silicate was filtered, washed, dewatered, spray dried and milled.

To form granules and increase product density, 100 g of the dried particles prepared above were compacted in a lab roller compactor (TFC-Labo available from Vector Incorporated, Marion, Iowa) using a pressing force 7 bar to form ribbon-shaped agglomerates, which were then comminuted in a grinding process by forcing through a 20 mesh screen). The crude granules obtained were approximately 70 g of 400-1600 μm sized granules. The granules were then sized by sieving as described above to recover granules sized between 850 μm and 425 μm. Physical properties of Example 12 were determined according to the methods described above and results are summarized in Table 1 below.

Several properties of this example were determined according to the methods described above and are summarized in Table 1 below.

### EXAMPLE 2

This example involved the wet-mixing of 115 g of Example 1 complex silicate with 700 g deionized water with calcium hydroxide to form sodium calcium magnesium aluminosilicate. To the already formed suspension, 19.14 g of dry calcium hydroxide (Chemstone Lime D-769) and 300 g Deionized water were then added. The reaction mixture was heated to 96° C. and cooked for 2 hours, then filtered, washed and dried for 16 hr in an oven set at 105° C. and roller compacted to form granules using methods described in Example 1. Several properties of this example were determined according to the methods described above and are summarized in Table 1 below.

### EXAMPLE 3

Example 4 was produced by mixing 100 g of the granulated SMAS from Example 1 with 100 g of synthetic calcium silicate (Hubersorb® 600, J. M. Huber) roller compacted to form granules using methods described in Example 1 (CH870-80-2). The two granular materials were placed in a PK V-blender and mixed for 5 minutes to obtain a uniform mixture.

### EXAMPLE 4

Example 4 was produced by mixing 200 g of the granulated SMAS from Example 1 with 100 g of synthetic calcium silicate (Hubersorb 600, J. M. Huber) roller compacted to form granules using methods described in Example 1 (CH870-80-2). The two granular materials were placed in a PK V-blender and mixed for 5 minutes to obtain a uniform mixture.

### COMPARATIVE EXAMPLE 1

Comparative Example 1 was produced by mixing 134.4 g of Example 1 complex silicate and 1000 g deionized water to create a suspension. To this suspension, 22.8 g of 50% magnesium hydroxide, Mg(OH)₂, was added with agitation. The mixture was heated to 90° C. and cooked for 2 hrs, while continuing agitation. The final mixture was filtered to recover the solids and the solids were dried for 16 hr in an oven set at 105° C. and roller compacted to form granules using methods described in Example 1. Several properties of this example were determined according to the methods described above and are summarized in Table 1 below.

### COMPARATIVE EXAMPLE 2

Comparative Example 2 is commercially produced magnesium silicate, Magnesol® XL from the Dallas Group Several properties of this example were determined according to the methods described above and are summarized in Table 1 below.

TABLE 1

| | | | Comparative | Comparative |
|---|---|---|---|---|
| | Example 1 | Example 2 | Example 1 | Example 2 |
| BET, m2/g | 40 | 66 | 45 | 400 |
| Pack density, g/cc | 0.408 | 0.322 | 0.312 | 0.432 |
| Pour density, g/cc | 0.271 | 0.154 | 0.176 | 0.368 |
| MPS, μm | 200 | 200 | 200 | 115 |
| Oil Absorption, ml/ | 142 | 122 | 117 | — |
| 100 g | | | | |
| 5% pH | 10.2 | 11.4 | 11.0 | 9.8 |
| % SiO₂ | 65.4 | 58.3 | 60.74 | 69.9 |
| % Na₂O | 8.3 | 5.2 | 6.86 | <1 |
| % Al₂O₃ | 11.4 | 8.92 | 10.95 | <1 |
| % MgO | 1.6 | 1.56 | 7.67 | 18.1 |
| % CaO | 0.4 | 11.59 | 0.17 | <1 |
| % Na₂SO₄ | 3.6 | 2.61 | 1.06 | — |
| % LOI | 10.5 | 10.99 | 11.38 | 12 |

Test 1 involved recovering a sample of abused oil after several days of frying a variety of food products, including meats, fish and vegetables. Oil samples were obtained just prior to oil disposal. The oil was reheated in a small commercial fryer (Fry Daddy, Presto, Inc.) to 360° F. From the fryer is extracted 100 g, placed into a 250 cc beaker and digested for 15 minutes. It is then filtered using a vacuum Buchner funnel and Whatman #1 paper to remove any solids. The clarified oil was cooled and stored refrigerated until testing.

Similarly, Test 2 involved recovering a sample of abused oil after several days of flying a variety of food products, primarily consisting of poultry, beef and pork. Oil samples were obtained just prior to oil disposal. The oil was reheated in a small commercial fryer (Fry Daddy, Presto, Inc.) to 360° F. From the fryer is extracted oil that is placed into a 250 cc beaker with the desired amount of absorbent to yield 100 total grams. The mixture is digested for 15 minutes, maintaining 360° F. It is then filtered using a vacuum buchner funnel and Whatman #1 paper to recover any solids. The clarified oil was cooled and stored refrigerated until testing.

### Performance Evaluation

Several absorbents were tested using the methods described above before being recovered and analyzed. The composition of the various tests is shown in Table 2 below.

TABLE 2

| | | | | Wt |
|---|---|---|---|---|
| | | | | Ab- |
| | | | Wt | sorbent, |
| Test | Absorbent | Oil Source | Oil, g | g |
| 1 | 0% | Abused Commercial Oil 1 | 100 | 0 |
| 1 | 1% Example 1 | Abused Commercial Oil 1 | 99 | 1 |
| 1 | 5% Example 1 | Abused Commercial Oil 1 | 95 | 5 |
| 1 | 10% Example 1 | Abused Commercial Oil 1 | 90 | 10 |
| 1 | 1% Magnesol XL | Abused Commercial Oil 1 | 99 | 1 |
| 1 | 5% Magnesol XL | Abused Commercial Oil 1 | 95 | 5 |
| 2 | 0% | Abused Commercial Oil 2 | 100 | 0 |
| 2 | 1% Example 1 | Abused Commercial Oil 2 | 99 | 1 |
| 2 | 5% Example 1 | Abused Commercial Oil 2 | 95 | 5 |
| 2 | 10% Example 1 | Abused Commercial Oil 2 | 90 | 10 |
| 2 | 1% Magnesol XL | Abused Commercial Oil 2 | 99 | 1 |
| 2 | 5% Magnesol XL | Abused Commercial Oil 2 | 95 | 5 |

Oil samples were tested by Intertek Agri Services St. Rose, La. Samples were tested for Total Polar Compounds, Lovibond Color and Free fatty Acids using the methods described above.

The absorbent of this invention was analyzed and found to provide the following benefits.

TABLE 3

| | | Free |
|---|---|---|
| | Absorbent | Fatty |
| Test | Amount, % | Acids |
| 1 | 0% | 2.68 |
| 1 | 1% Example 1 | 1.9 |
| 1 | 5% Example 1 | 1.55 |
| 1 | 10% Example 1 | 1.48 |
| 1 | 0% | 2.68 |
| 1 | 1% Magnesol XL | 1.55 |
| 1 | 5% Magnesol XL | 1.34 |
| 2 | 0% | 0.63 |
| 2 | 1% Example 1 | 0.68 |
| 2 | 5% Example 1 | 0.68 |
| 2 | 10% Example 1 | 0.56 |
| 2 | 0% | 0.63 |
| 2 | 1% Magnesol XL | 0.63 |
| 2 | 5% Magnesol XL | 0.42 |

The absorbent of this invention shows a significant reduction in FFA values as the addition level is increased from 0 to 10% and the level of total polar compounds was observed to increase less than the commercial magnesium silicate. The observed color of the treated oils was measured empirically and was found to be comparable to that of the commercial magnesium silicate as well at a laboratory scale.

Test 3 involved recovering a sample of abused oil after several days of frying a variety of food products, primarily poultry from another commercial source. Oil samples were obtained just prior to oil disposal. The oil was reheated in a small commercial fryer (Fry Daddy, Presto, Inc.) to 360° F. From the fryer is extracted 100 g, placed into a 250 cc beaker and digested for 15 minutes. It is then filtered using a vacuum buchner funnel and Whatman #1 paper to remove any solids. The clarified oil was cooled and stored refrigerated until testing.

TABLE 4

| | | | | Wt |
|---|---|---|---|---|
| | | | | Ab- |
| | | | Wt | sorbent, |
| Test | Absorbent | Oil Source | Oil, g | g |
| 3 | 0% | Abused Commercial Oil 3 | 100 | 0 |
| 3 | 1% Magnesol XL | Abused Commercial Oil 3 | 99 | 1 |
| 3 | 5% Magnesol XL | Abused Commercial Oil 3 | 95 | 5 |
| 3 | 1% Example 2 | Abused Commercial Oil 3 | 90 | 1 |
| 3 | 5% Example 2 | Abused Commercial Oil 3 | 99 | 5 |
| 3 | 1% Comp Example | Abused Commercial Oil 3 | 95 | 1 |
| | new | | | |
| 3 | 5% Comp Example | Abused Commercial Oil 3 | 100 | 5 |
| | new | | | |
| 3 | 1% Example 4 | Abused Commercial Oil 3 | 99 | 1 |
| 3 | 5% Example 4 | Abused Commercial Oil 3 | 95 | 5 |
| 3 | 1% Example 5 | Abused Commercial Oil 3 | 90 | 1 |
| 3 | 5% Example 5 | Abused Commercial Oil 3 | 99 | 5 |

TABLE 5
Oil Performance Test 3

| | Free Fatty Acids |
|---|---|
| 0% | 0.63 |
| 1% Magnesol XL | 0.62 |
| 5% Magnesol XL | 0.39 |
| 0% | 0.63 |
| 1% Example 2 | 0.55 |
| 5% Example 2 | 0.3 |
| 0% | 0.63 |
| 1% Comp Example new | 0.63 |
| 5% Comp Example new | 0.56 |
| 0% | 0.63 |
| 1% Example 4 | 0.56 |
| 5% Example 4 | 0.33 |
| 0% | 0.63 |
| 1% Example 5 | 0.58 |
| 5% Example 5 | 0.42 |

Furthermore, when introduced within an actual restaurant setting, the amount of needed fat or oil to supplemental the used source after filtering with the inventive material was less than that needed for the same amount of magnesium silicate filter medium. Likewise, on such a larger scale, the color of the used oil filtered by the inventive medium was found to empirically be better than that of the comparative magnesium silicate products.

While the invention will be described and disclosed in connection with certain preferred embodiments and practices, it is in no way intended to limit the invention to those specific embodiments, rather it is intended to cover equivalent structures structural equivalents and all alternative embodiments and modifications as may be defined by the scope of the appended claims and equivalence thereto.

What is claimed is:

1. A mixture of sodium magnesium aluminosilicate and calcium silicate.

2. The mixture of claim 1 wherein said sodium magnesium aluminosilicate and said calcium silicate are dry-blended together.

3. The mixture of claim 1 wherein said sodium magnesium aluminosilicate is granulated.

4. The mixture of claim 1 wherein said calcium silicate is granulated.

5. The mixture of claim 1 wherein both said sodium magnesium aluminosilicate and said calcium silicate are granulated.

6. The mixture of claim 2 wherein said sodium magnesium aluminosilicate is granulated.

7. The mixture of claim 2 wherein said calcium silicate is granulated.

8. The mixture of claim 2 wherein both said sodium magnesium aluminosilicate and said calcium silicate are granulated.

9. A method for treating cooking oil or fat comprising contacting cooking oil or fat with (a) at least one magnesium silicate and (b) at least one calcium silicate.

10. The method of claim 9 where said at least one magnesium silicate is sodium magnesium aluminosilicate.

11. The method of claim 10 wherein said sodium magnesium aluminosilicate is granulated.

12. The method of claim 10 wherein said at least one calcium silicate is granulated.

13. The method of claim 10 wherein said at least one magnesium silicate and said at least one calcium silicate are dry-blended together prior to contacting with said cooking oil or fat.

14. The method of claim 13 wherein said at least one magnesium silicate is sodium magnesium aluminosilicate.

15. The method of claim 13 wherein said calcium silicate is granulated.

16. The method of claim 13 wherein both said sodium magnesium aluminosilicate and said calcium silicate are granulated.
